(19) United States
(12) Patent Application Publication
(10) Pub. No.: US 2015/0025990 A1
(43) Pub. Date: Jan. 22, 2015

(54) COMMODITY SALES DATA PROCESSING APPARATUS, INFORMATION TERMINAL AND CONTROL METHOD

(71) Applicant: Toshiba TEC Kabushiki Kaisha, Tokyo (JP)

(72) Inventor: Kenya Suzuki, Shizuoka-ken (JP)

(21) Appl. No.: 14/331,458

(22) Filed: Jul. 15, 2014

(30) Foreign Application Priority Data
Jul. 16, 2013 (JP) 2013-147855

(51) Int. Cl. G06Q 20/20; G06F 1/16

(52) U.S. Cl. CPC G06Q 20/201; G06F 1/1632
USPC 705/20

(57) ABSTRACT

In accordance with one embodiment, a commodity sales data processing apparatus comprises a stationary type docking station, and a portable information terminal which can be attached to and detached from the docking station freely. The information terminal reads the data attached to a commodity, registers the read data, displays the registration content, and executes, if the information terminal is attached to the docking station, a checkout processing of calculating a checkout amount based on the registration content.

### CROSS-REFERENCE TO RELATED APPLICATION

This application is based upon and claims the benefit of priority from Japanese Patent Application No. 2013-147855, filed Jul. 16, 2013, the entire contents of which are incorporated herein by reference.

### FIELD

Embodiments described herein relate to an information terminal, a control method and a commodity sales data processing apparatus provided with a portable information terminal.

### BACKGROUND

There is known a system in which a device for attaching an electronic tag to a commodity and reading the information of the electronic tag in a contactless manner is arranged on a commodity conveyance shopping cart, and the information read by the device is sent to, for example, a POS (Point Of Sales) terminal serving as a commodity sales data processing apparatus of a register counter to carryout settlement of the commodity.

If such a system is introduced into a store, the information of the commodities is automatically registered by putting the commodities into the shopping cart, thus, the work of scanning the commodity to read the commodity information contained in a barcode and the like is no longer necessary.

However, in a case of the system mentioned above, it is necessary to arrange one device for reading and sending the information of the electronic tag on every shopping cart, which leads to a high cost in the introduction of the system in a store having a lot of shopping carts.

On the other hand, the popularization and the price reduction of a portable information terminal, for example, a tablet type information terminal, which is capable of receiving information input through a touch operation of a finger on a display screen, is significant.

### BRIEF DESCRIPTION OF THE DRAWINGS

FIG. 1 is a diagram schematically illustrating a view of the whole store having the constitution according to one embodiment;

FIG. 2 is an external view illustrating a docking station and a tablet terminal according to the embodiment;

FIG. 3 is a diagram illustrating a state in which the tablet terminal is detached from the docking station according to the embodiment;

FIG. 4 is an external view illustrating a shopping cart on which the tablet terminal according to the embodiment can be arranged;

FIG. 5 is a diagram illustrating the shopping cart on which the tablet terminal according to the embodiment is arranged;

FIG. 6 is a schematic diagram illustrating the constitution of a POS system according to the embodiment;

FIG. 7 is a block diagram illustrating the main portions of the docking station and the tablet terminal according to the embodiment;

FIG. 8 is a flowchart illustrating the control executed by a CPU of the tablet terminal according to the embodiment;

FIG. 9 is a diagram illustrating a registration screen of the tablet terminal in a case where the tablet terminal is arranged on the shopping cart according to the embodiment;

FIG. 10 is a diagram illustrating promotion information pop-up displayed on the registration screen shown in FIG. 9;

FIG. 11 is a diagram illustrating a commodity retrieval screen of the tablet terminal according to the embodiment;

FIG. 12 is a diagram illustrating a retrieval result display screen displayed after FIG. 11;

FIG. 13 is a diagram illustrating a stock confirmation screen of the tablet terminal according to the embodiment;

FIG. 14 is a diagram illustrating a confirmation result display screen displayed after FIG. 13;

FIG. 15 is a diagram illustrating a checkout screen of the tablet terminal according to the embodiment; and

FIG. 16 is a diagram illustrating a checkout-unwanted notification screen of the tablet terminal according to the embodiment.

### DETAILED DESCRIPTION

In accordance with one embodiment, a commodity sales data processing apparatus comprises a stationary type docking station, and a portable information terminal which can be attached to and detached from the docking station freely. The information terminal reads the data attached to a commodity, registers the read data, displays the registration content, and executes, if the information terminal is attached to the docking station, a checkout processing of calculating a checkout amount based on the registration content.

One embodiment of the commodity sales data processing apparatus is described below with reference to the accompanying drawings. In the present embodiment, a commodity sales data processing apparatus is exemplified which realizes a function of a POS terminal by using a tablet type information terminal.

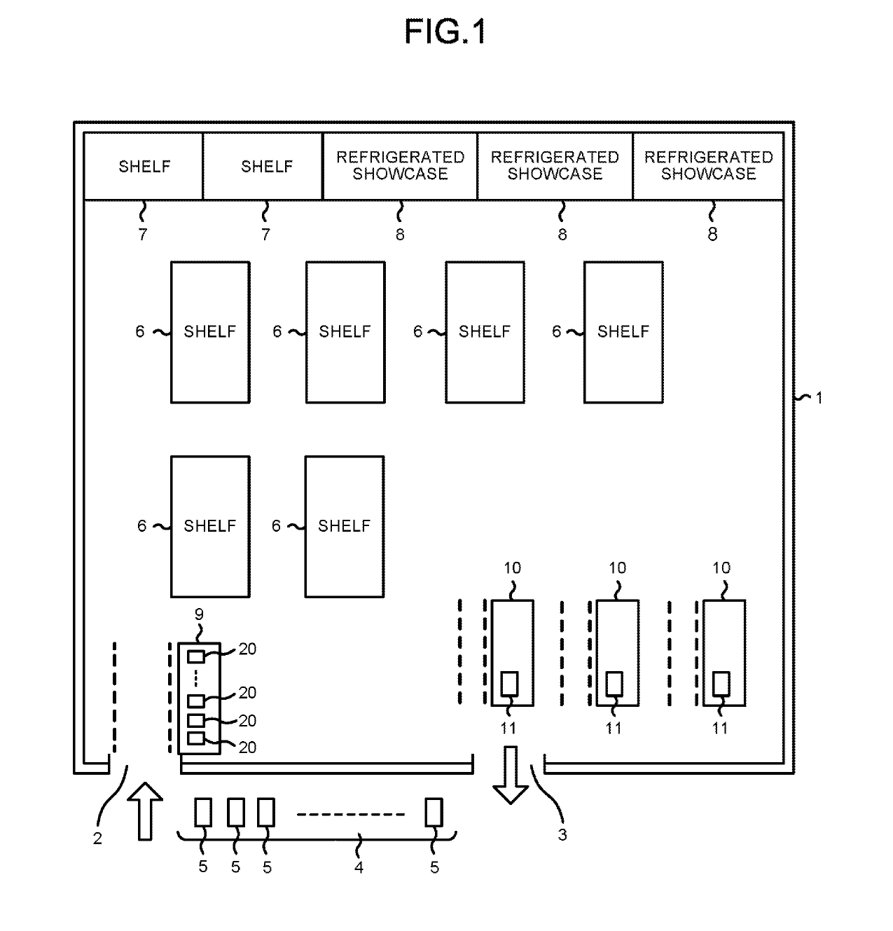

In FIG. 1, “1” refers to a store which sells commodities and comprises an entrance 2 and an exit 3 for customers and a shopping cart storage area 4 arranged nearby the entrance 2 and the exit 3. A lot of shopping carts 5 serving as commodity carriers are stored in the shopping cart storage area 4 in such a manner that the shopping carts 5 can be taken in and out.

A lot of commodity shelves 6 are arranged in dispersion inside the store 1, and a plurality of commodity shelves 7 and a plurality of refrigerated showcases 8 are arranged along the inner wall of the store 1. At the inside of the store 1, at least one terminal lending counter 9 is arranged nearby the entrance 2 and a plurality of register counters 10 are arranged nearby the exit 3.

In such a store 1, one stationary type docking station 11 is arranged at each register counter 10. A plurality of information terminals, for example, tablet type information terminals (hereinafter referred to as tablet terminal for short) 20 each of which constitutes a commodity sales data processing apparatus with each docking station 11 are placed on the terminal lending counter 9. The number of the placed tablet terminals 20 is the more the better so that they can be lent to a lot of customers.

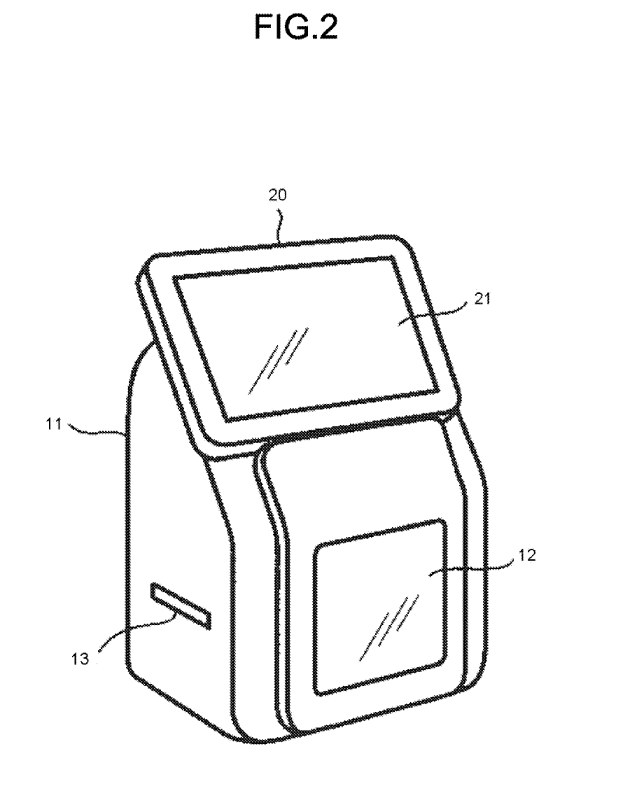

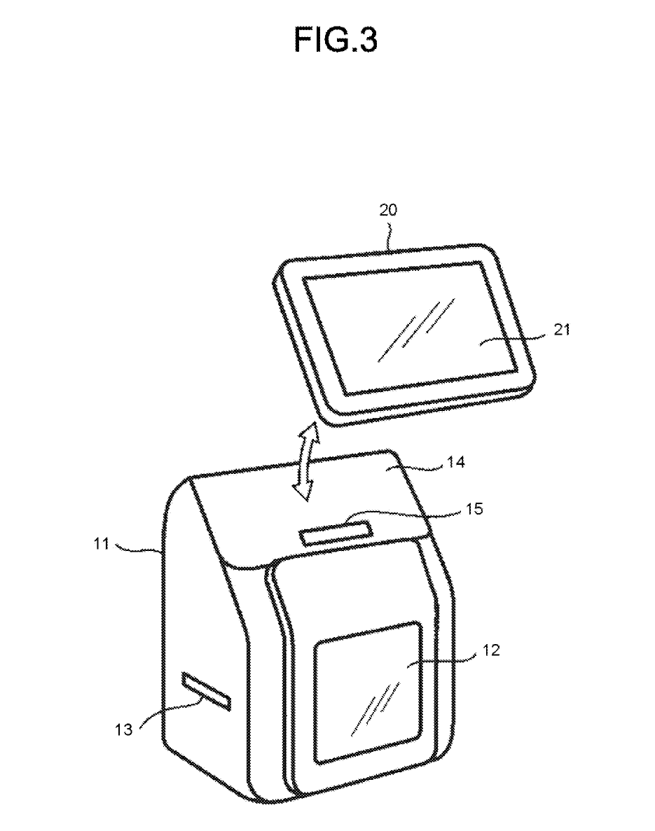

The tablet terminal 20 can be attached to and detached from the docking station 11 on the register counter 10. FIG. 2 shows a state in which the tablet terminal 20 is attached to the docking station 11 and FIG. 3 shows a state in which the tablet terminal 20 is detached from the docking station 11.

That is, as shown in FIG. 2, the docking station 11 includes a box-shaped housing on the upper portion of which the tablet terminal 20 is attached (placed), a reading window 12 of a scanner arranged in the front of the housing and a receipt issue port 13 arranged at the left side of the housing. If the tablet terminal 20 is lifted and detached from the docking station 11, as shown in FIG. 3, an inclined terminal mounting portion 14 on the upper portion of the housing of the docking station 11 appears, and an extension connector 15 arranged on the terminal mounting portion 14 is exposed.

The tablet terminal 20 includes a rectangular-shaped housing that can be held with one hand, a touch panel type display section 21 which is arranged on the upper surface of the housing and is capable of receiving a touch operation by a finger, and a docking connector 69 which is arranged at the back side of the housing and will be described later. The docking connector 69 is inserted into the extension connector 15 while the back side of the tablet terminal 20 is placed on the terminal mounting portion 14 of the docking station 11, in this way, the tablet terminal 20 and the docking station 11 are electrically connected with each other. Such an electrical connection can be released easily by lifting the tablet terminal 20 and separating the tablet terminal 20 from the terminal mounting portion 14.

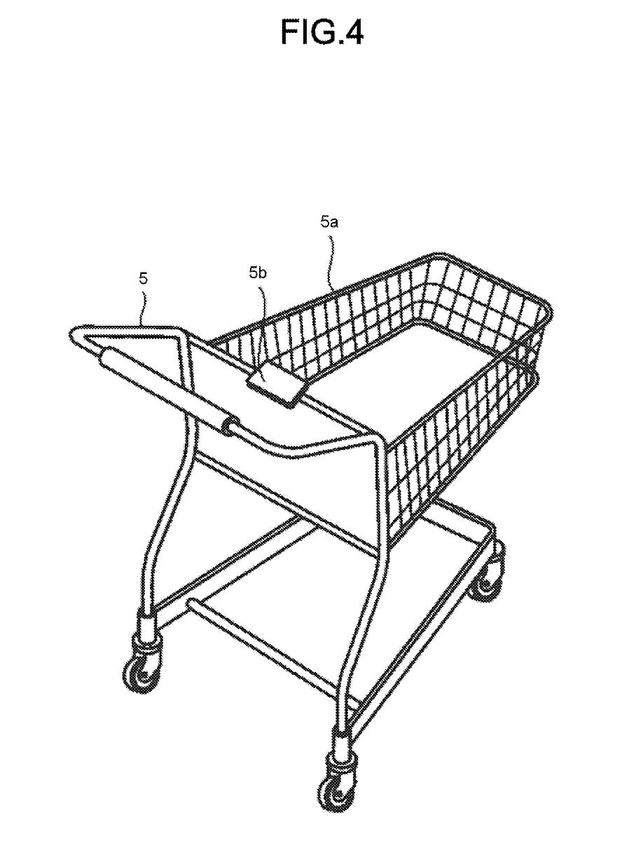

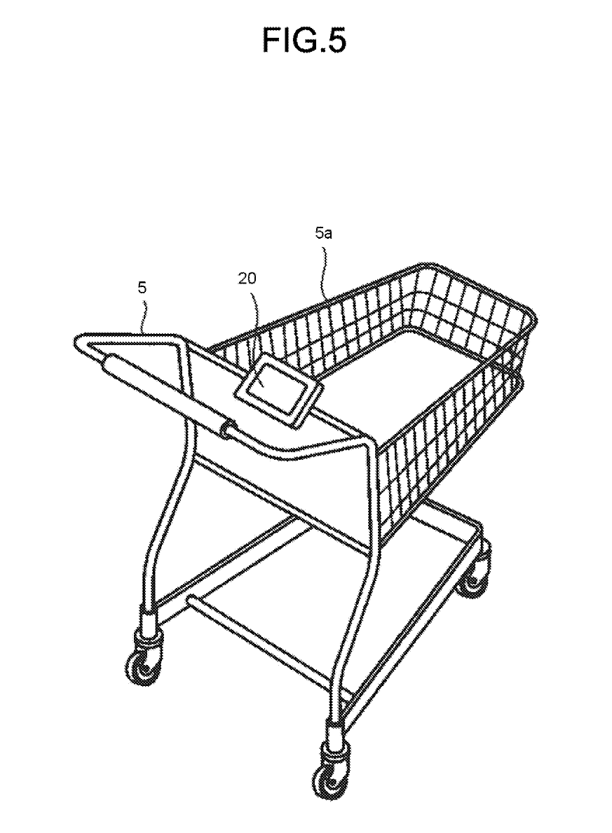

As shown in FIG. 4, each shopping cart 5 of the shopping cart storage area 4 has a cage-like housing section 5a and a base plate 5b which is arranged on the housing section 5a near the side of a customer and is used for the attachment of the tablet terminal. A customer coming to the store 1 takes out one shopping cart 5 from the shopping cart storage area 4, enters the store together with the shopping cart 5 through the entrance 2, and inserts and attaches the tablet terminal 20 borrowed from an shop clerk of the terminal lending counter 9 onto the base plate 5b of the shopping cart 5, as shown in FIG. 5. Such an attachment can be easily released by lifting the tablet terminal 20 up and separating the tablet terminal 20 from the base plate 5b. The attachment and the detachment of the tablet terminal 20 to and from the base plate 5b of the shopping cart 5 is mechanically or magnetically detected by a shopping cart mounting sensor 71 which will be described later.

One docking station 11 and one tablet terminal 20 constitute a commodity sales data processing apparatus.

As the operation of a store, the tablet terminal 20 on the terminal lending counter 9 is lent to a customer by a shop clerk, and when the customer receiving the tablet terminal 20 puts the desired commodities in the shopping cart 5 and comes to the register counter 10, the tablet terminal 20 is returned to the shop clerk from the customer. The shop clerk receiving the returned tablet terminal 20 attaches the received tablet terminal 20 to the docking station 11 and carries out checkout processing as a general POS terminal according to the display of the touch panel type display section 21 of the tablet terminal 20. The shop clerk completing the checkout detaches the tablet terminal 20 from the docking station 11 and returns the detached tablet terminal 20 to the terminal lending counter 9.

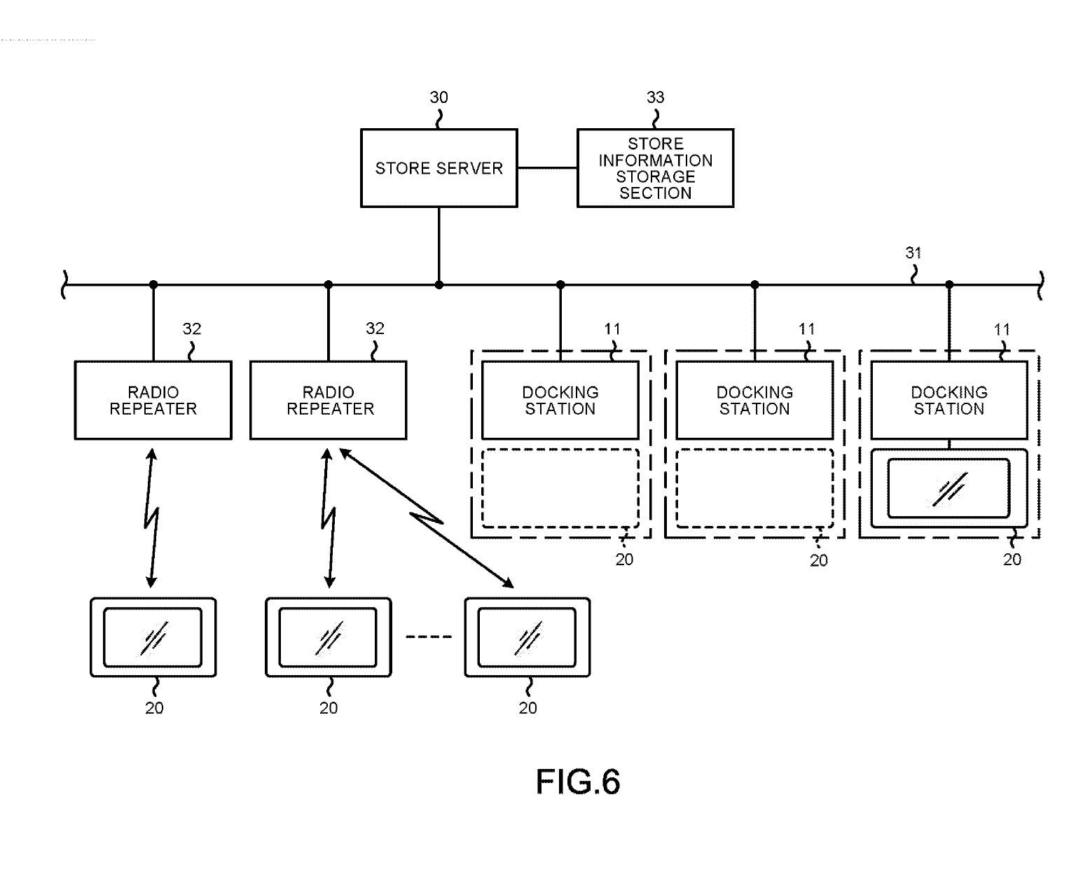

FIG. 6 is a diagram schematically illustrating the constitution of a POS system which uses a commodity sales data processing apparatus including the docking station 11 and the tablet terminal 20. The POS system comprises a plurality of commodity sales data processing apparatuses and a store server which centrally manages these commodity sales data processing apparatuses. The docking station 11 of each commodity sales data processing apparatus and the store server 30 are connected with each other to be capable of carrying out bidirectional communication through a network 31 such as a LAN (Local Area Network). Further, the tablet terminal 20 of each commodity sales data processing apparatus and the store server 30 are connected with each other to be capable of carrying out bidirectional communication, through the network 31 and one or a plurality of radio repeaters 32 connected with the network 31. The tablet terminal 20 can realize the function of the POS terminal both when attached to the docking station 11 and when detached from the docking station 11.

The store server 30 is provided with a store information storage section 33 which stores various kinds of information of the store 1 in an updatable manner. The various kinds of information of the store 1 includes the information indicating where a commodity is in the store 1 for each commodity, the information indicating the stock state and the quantity of commodity of the store 1, and the like.

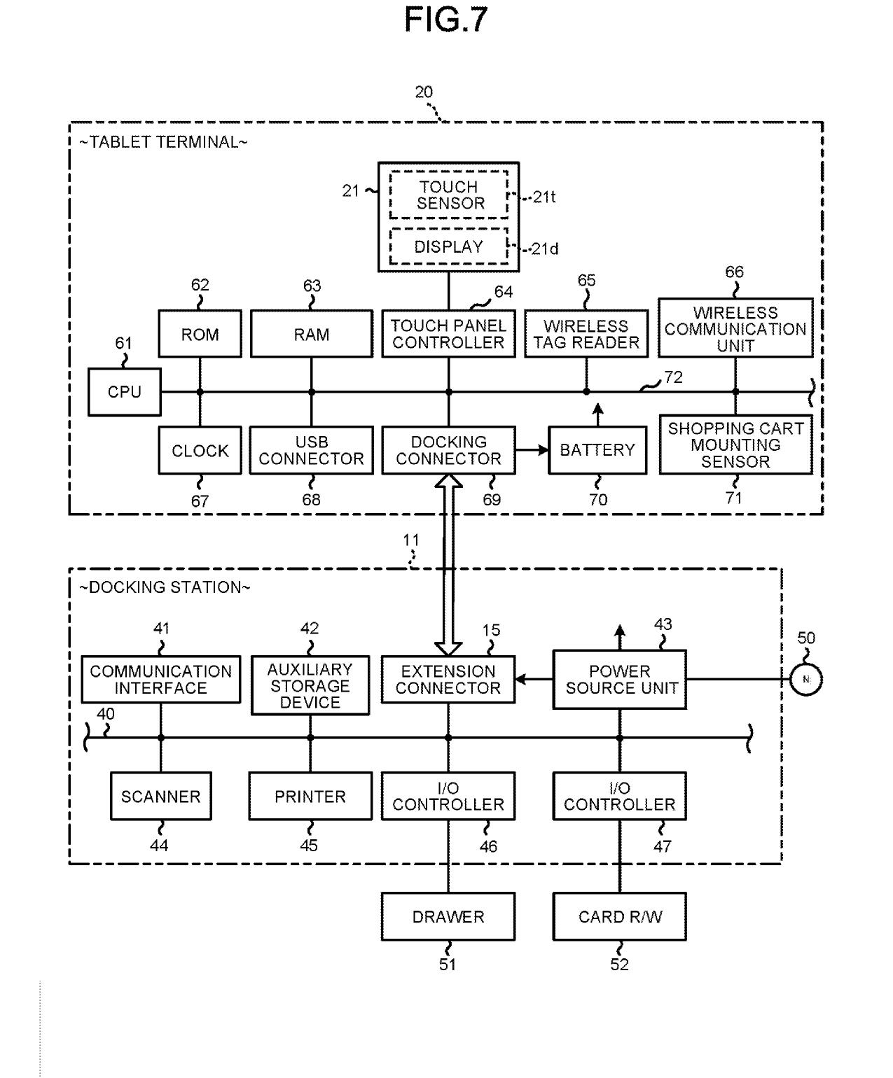

The main portions of the docking station 11 and the tablet terminal 20 are shown in FIG. 7.

In addition to the extension connector 15 mentioned above, the docking station 11 further includes a communication interface 41, an auxiliary storage device 42, a power source unit 43, a scanner 44, a printer 45 and I/O controllers 46 and 47 at least. The communication interface 41, the auxiliary storage device 42, the power source unit 43, the scanner 44, the printer 45 and the I/O controllers 46 and 47 are connected with each other through a bus line 40 such as an address bus line, a data bus line and the like.

The communication interface 41 is connected with the network 31. The communication interface 41 performs data transmission/reception between the tablet terminal 20 and the store server 30 through the network 31.

The auxiliary storage device 42 is an auxiliary storage part of a computer. The auxiliary storage device 42 is, for example, an EEPROM (electric erasable programmable read-only memory), a HDD (Hard Disk Drive), or a SSD (solid state drive) and the like. The auxiliary storage device 42 stores data used when a CPU 61 of the tablet terminal 20 carries out various processing and data generated in the processing carried out by the CPU 61. As occasion demands, the auxiliary storage device 42 also stores an application program.

The power source unit 43 converts the voltage of a commercial-use AC power source 50 into the operation voltage of the docking station 11 and then outputs the converted voltage, and outputs charging voltage to the tablet terminal 20. The charging voltage is supplied for the tablet terminal 20 through the extension connector 15.

The scanner 44 optically reads a barcode and the like held over the reading window 12. The scanner 44 may also be a scanner which reads a barcode and the like attached to a commodity from a commodity image captured by a camera.

The printer 45 carries out printing on conveyed roll paper by a thermal system, for example. The printed roll paper is discharged from the receipt issue port 13 and cut and then issued as a receipt. The printer 45 can use label paper as the roll paper to issue a label. Further, the printer 45 may also be a printer different from a thermal type printer.

The I/O controllers 46 and 47 are connected to, for example, a USB connector arranged at the back or side of the housing of the docking station 11 in an exposed manner. The I/O controller 46 controls an external machine, for example, a drawer 51, which is connected to the USB connector. The I/O controller 47 controls an external machine, for example, a card reader-writer 52, which is connected to the USB port. The card reader-writer 52 is capable of carrying out data reading/writing processing on an electronic money card.

On the other hand, the tablet terminal 20 comprises a CPU (Central Processing Unit) 61, a ROM (Read Only Memory) 62, a RAM (Random Access Memory) 63, a touch panel controller 64, a reading module such as a wireless tag reader 65, a wireless communication unit 66, a clock 67, a USB (Universal Serial Bus) connector 68, a docking connector 69, a battery 70, a shopping cart mounting sensor 71 and the like. The CPU 61 is connected with the ROM 62, the RAM 63, the touch panel controller 64, the wireless tag reader 65, the wireless communication unit 66, the clock 67, the USB connector 68, the docking connector 69, and the shopping cart mounting sensor 71 through a bus line 72 such as an address bus line, a data bus line and the like.

The CPU 61 is a central part of a computer. The CPU 61 controls each section to achieve various functions of the POS terminal according to an operating system or an application program.

The ROM 62 is a main storage part of the computer. The ROM 62 stores the operating system and the application program mentioned above. As occasion demands, the ROM 62 also stores data required to execute various processing by the CPU 61.

The RAM 63 is also a main storage part of the computer mentioned above. The RAM 63 stores data required to execute various processing by the CPU 61 as needed. Further, the RAM 63 is also used as a work area for the CPU 61 when various processing is executed.

The touch panel type display section 21 is constituted by arranging a touch sensor 21t serving as an input section at the display part of a display 21d. The touch panel controller 64 connected with the touch panel type display section 21 controls the screen display of the display 21d and monitors a signal of the touch sensor 21t. The touch panel controller 64 detects input data according to the coordinate information of the touched position and the screen information of the display 21d at the time of the touch operation.

The wireless tag reader 65, which reads a commodity identification code in a wireless tag (IC chip) pre-attached to a commodity in the store 1 in a contactless manner through transmission/reception of electric wave with the wireless tag, includes a space three-dimensionally containing the housing section 5a of the shopping cart 5 as a maximum reading area.

The wireless communication unit 66 performs data transmission/reception with the radio repeater 32 through a wireless communication. The clock 67 clocks the current date and time.

The USB connector 68 is a connector for connecting various USB devices having a communication system based on a USB standard in a detachable manner. The drawer 51 and the card reader-writer 52 mentioned above can be connected with the USB connector 68.

The docking connector 69, which is used to connect the tablet terminal 20 with the docking station 11, is arranged at the back side of the housing of the tablet terminal 20.

The battery 70, which is used to output operation voltage of the tablet terminal 20, is charged by the charging voltage supplied from the docking station 11 through the extension connector 15 and the docking connector 69 in a case where the tablet terminal 20 is attached to the docking station 11.

The shopping cart mounting sensor 71, which is arranged at the back of the housing of the tablet terminal 20, mechanically or magnetically detects the attachment and the detachment of the tablet terminal 20 to and from the base plate 5b of the shopping cart 5. For example, as a mechanical detection method, a switch which is closed when the tablet terminal 20 is contacted with the base plate 5b and is opened when the tablet terminal 20 is separated from the base plate 5b may be used. As a magnetic detection method, a magnet is arranged in the base plate 5b, and the magnetic field of the magnet is detected through hall element.

The CPU 61 includes the following modules (1)-(5) as main functions based on the application program in the ROM 62:

(1) an input module configured to receive the touch operation by a finger and the like on the touch panel type display section 21 as the input of data relating to the commodity sales;

(2) a registration module configured to process the input data received by the input module and the data read by the wireless tag reader 65 as the commodity sales data and register the processed commodity sales data in the RAM 63;

(3) a display module configured to display the registration content of the registration module on the touch panel type display section 21;

(4) a determination module configured to determine whether or not the tablet terminal 20 is attached to the docking station 11. More specifically, the determination module sends a confirmation signal through the docking connector 69, and determines that the tablet terminal 20 is attached to the docking station 11 if the confirmation signal returns to the docking connector 69 and determines that the tablet terminal 20 is not attached to the docking station 11 if the confirmation signal does not return to the docking connector 69; and

(5) a processing module configured to execute a checkout processing of calculating the checkout amount based on the registration content of the registration module if the determination module determines that the tablet terminal 20 is attached to the docking station 11.

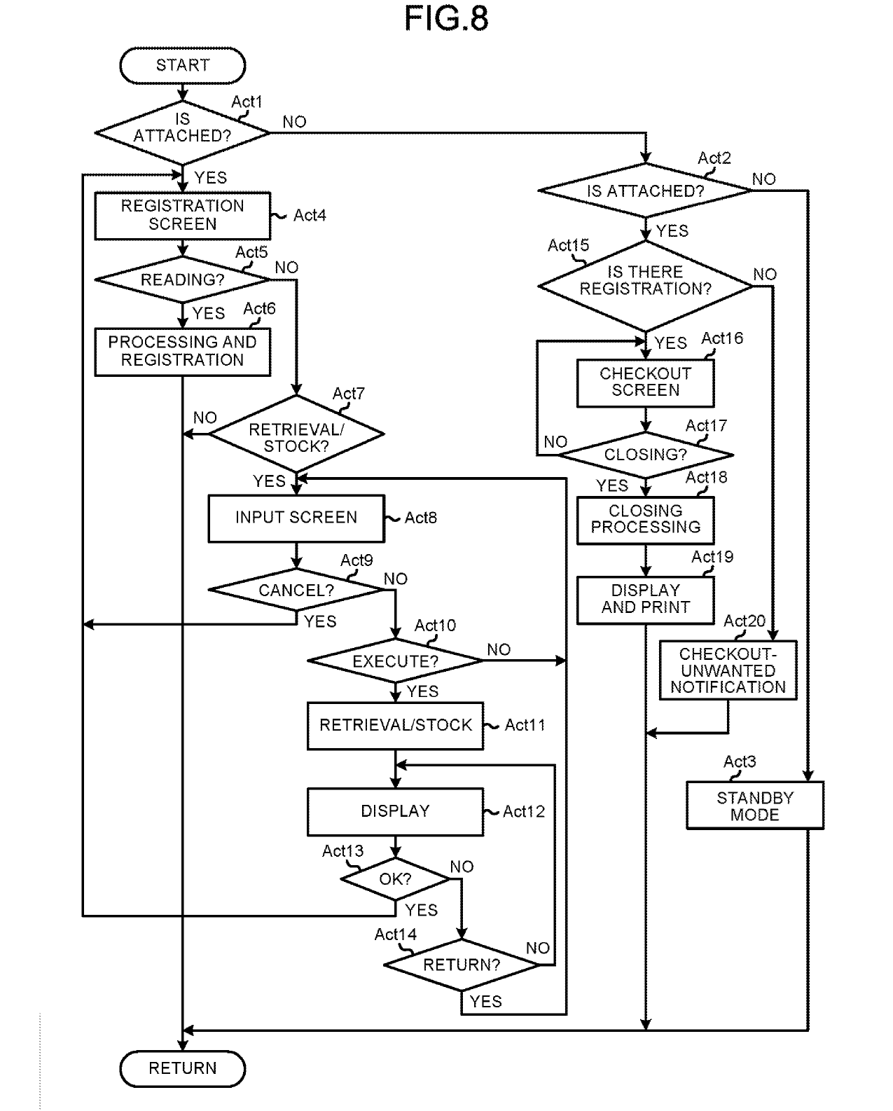

Next, the control executed by the CPU 61 of the tablet terminal 20 is illustrated with reference to the flowchart shown in FIG. 8.

The CPU 61 determines whether or not the tablet terminal 20 is attached to the shopping cart 5 according to the output of the shopping cart mounting sensor 71 (ACT 1), and determines whether or not the tablet terminal 20 is attached to the docking station 11 by sending a confirmation signal through the docking connector 69 (ACT 2).

If the tablet terminal 20 is placed on the terminal lending counter 9, that is, if the tablet terminal 20 is not attached to the shopping cart 5 (NO in ACT 1), and the tablet terminal 20 is not attached to the docking station 11 (NO in ACT 2), the CPU 61 sets a standby mode, for example, a suspend state for saving power (ACT 3).

The shop clerk of the terminal lending counter 9 lends one tablet terminal 20 prepared on the terminal lending counter 9 to the customer when the customer enters with the shopping cart 5 through the entrance 2. The lending may be a free operation, or an operation charging a fee, or an operation subtracting a given use point from the service point of the customer, and the like.

The customer receiving the tablet terminal 20 attaches the received tablet terminal 20 to the base plate 5b of the shopping cart 5.

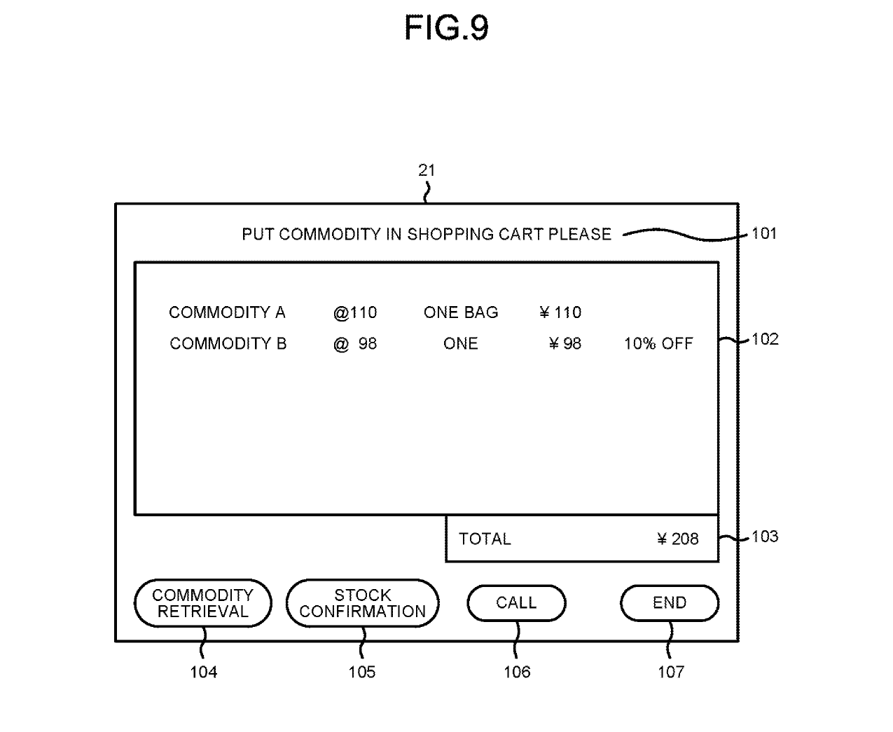

When the tablet terminal 20 is attached to the base plate 5b (YES in ACT 1), the CPU 61 displays a registration screen for commodity registration shown in FIG. 9 on the touch panel type display section 21 (ACT 4). The registration screen displays a guidance character 101 of “Put commodity in shopping cart please”, a commodity information display column 102, a total amount display column 103, a commodity retrieval button 104, a stock confirmation button 105, a call button 106, an end button 107 and the like.

If the customer puts desired commodity in the housing section 5a of the shopping cart 5, the commodity identification code of the wireless tag attached to the commodity is read by the wireless tag reader 65.

After the wireless tag reader 65 reads the identification data (YES in ACT 5), the CPU 61 acquires the unit price of the commodity corresponding to the read commodity identification code and the related information such as the discount relating to the commodity from the store server 30 through the wireless communication unit 66, processes the information as the commodity sales data, and registers the processed commodity sales data in the RAM 63 (ACT 6). During the registration, the CPU 61 displays the registration content on the commodity information display column 102.

The example of commodity information display column 102 shown in FIG. 9 indicates the following information: a bag of “commodity A” of which the unit price is 110 YEN is registered and the sub total thereof is 110 YEN; one “commodity B” of which the unit price is 98 YEN is registered and the sub total thereof is 98 YEN; and 10% discount is applied to the unit price of the “commodity B”. The example of the total amount display column 103 indicates that the current total amount is 208 YEN.

If one more bag of “commodity A” is put in the housing section 5a of the shopping cart 5, the display relating to the “commodity A” in the commodity information display column 102 changes to “two bag” and the sub total thereof changes to 220 YEN.

If one “commodity B” in the housing section 5a is taken out of the housing section 5a and returned to the commodity display shelf, the commodity identification code of the wireless tag attached to the “commodity B” cannot be read by the wireless tag reader 65, thus, the CPU 61 removes the commodity sales data relating to the taken out “commodity B” from the registered commodity sales data in the RAM 63, and deletes the display relating to the “commodity B” in the commodity information display column 102.

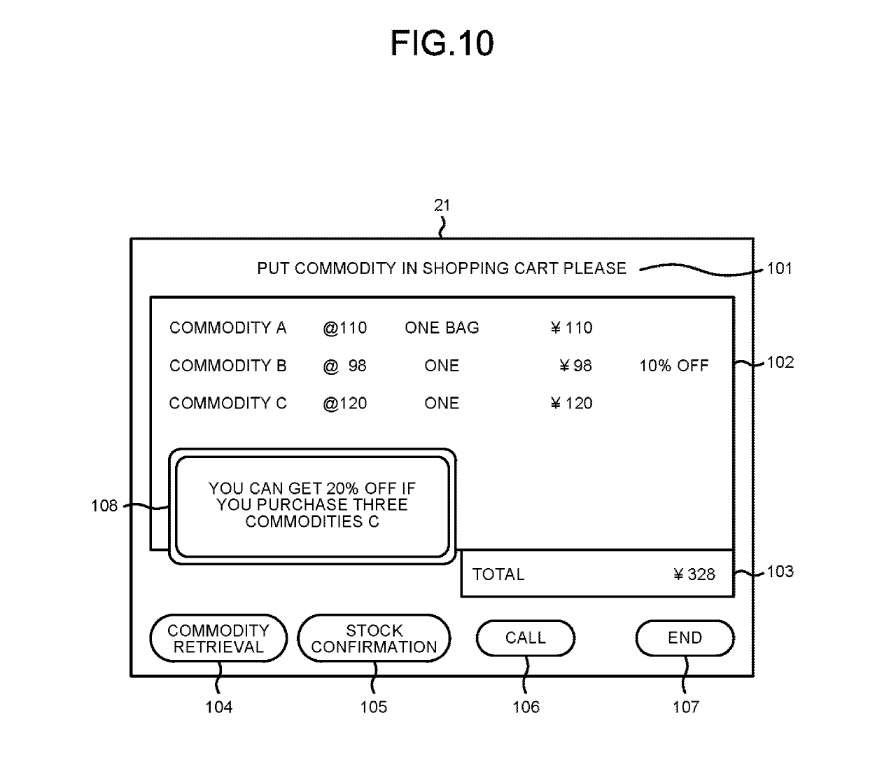

If the customer further puts another commodity, for example, one “commodity C” in the housing section 5a of the shopping cart 5, as shown in FIG. 10, the display relating to the “commodity C” is added to the commodity information display column 102. That is, the example of the display of the commodity information display column 102 shown in FIG. 10 indicates that one “commodity C” of which the unit price is 120 YEN is registered and the sub total thereof is 120 YEN. If there is promotion information relating to the registered “commodity C”, the CPU 61 pop-up displays the promotion information, for example, a guidance character 108 of “you can get 20% off if you purchase three commodities C” in the commodity information display column 102. The pop-up display is erased after a given time.

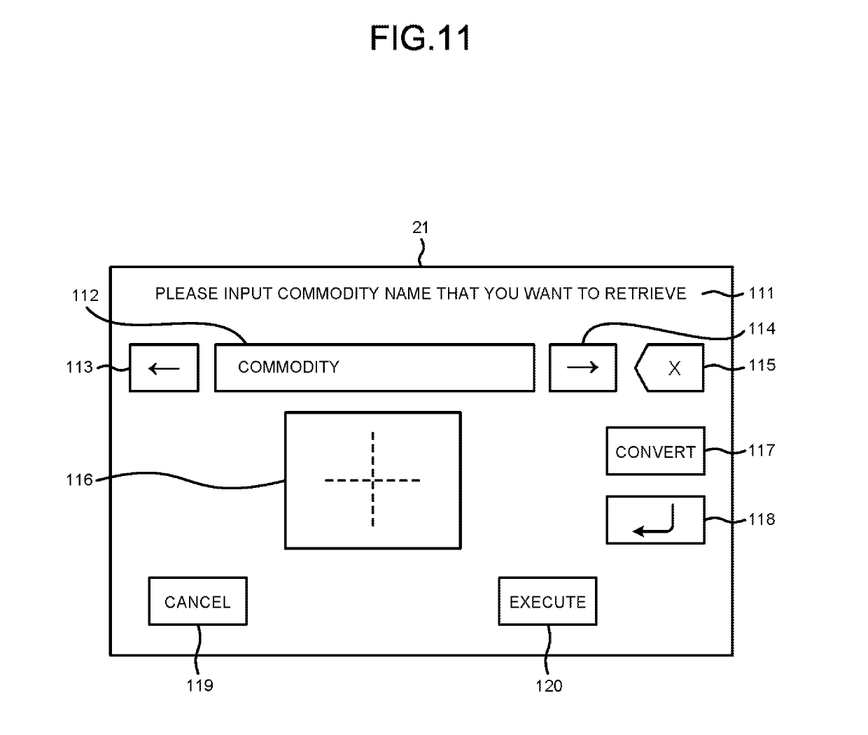

On the other hand, if the customer touches the commodity retrieval button 104 on the registration screen (YES in ACT 7), the CPU 61 displays an input screen for commodity retrieval shown in FIG. 11 on the touch panel type display section 21 (ACT 8). The input screen displays a guidance character 111 of “Please input commodity name that you want to retrieve”, an input character confirmation window 112, shift keys 113 and 114, a character deleting key 115, a handwritten character input column 116, a character conversion key 117, an input confirmation key 118, a retrieval cancel key 119, a retrieval execution key 120 and the like. The character input through a touch operation or a sliding operation in the handwritten character input column 116 is displayed in the input character confirmation window 112.

If the retrieval cancel key 119 is touched (YES in ACT 9), the CPU 61 returns to ACT 4 to display the registration screen.

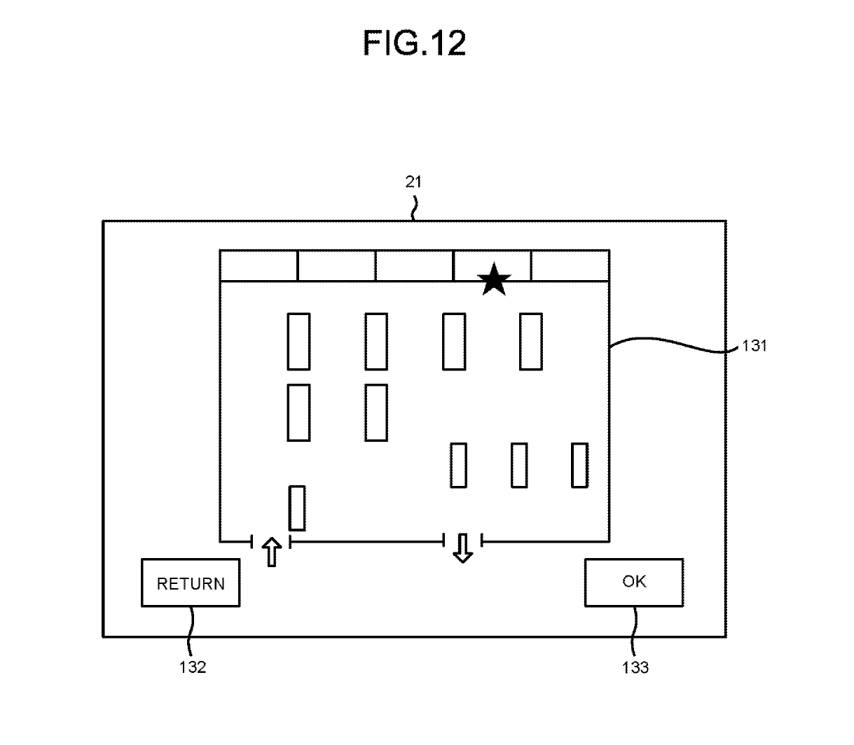

If the retrieval cancel key 119 is not touched and the retrieval execution key 120 is touched (NO in ACT 9, YES in ACT 10), the CPU 61 recognizes the commodity displayed in the input character confirmation window 112 and requests, through the wireless communication unit 66, the store server 30 to retrieve where the recognized commodity is in the store 1 (ACT 11). The store server 30 retrieves the display position of the commodity by reference to the store information storage section 33 based on the request and sends back the retrieval result to the CPU 61. The CPU 61 displays the retrieval result display screen shown in FIG. 12 on the touch panel type display section 21 based on the reply (ACT 12).

The retrieval result display screen includes a plane image pattern 131, a return button 132 and an OK button 133. The plane image pattern 131 shows the position of the commodity serving as retrieval target with a ★ mark and displays the positions of the commodity display shelves 6 and 7 and the refrigerated showcase 8 as well so that the customer can easily know where the commodity serving as retrieval target is in the store 1. The customer can easily find the desired commodity according to the retrieval result display screen.

If the OK button 133 of the retrieval result display screen is touched (YES in ACT 13), the CPU 61 returns to ACT 4 to display the registration screen. If the OK button 133 of the retrieval result display screen is not touched and the return button 132 is touched (NO in ACT 13, YES in ACT 14), the CPU 61 returns to ACT 8 to display the input screen.

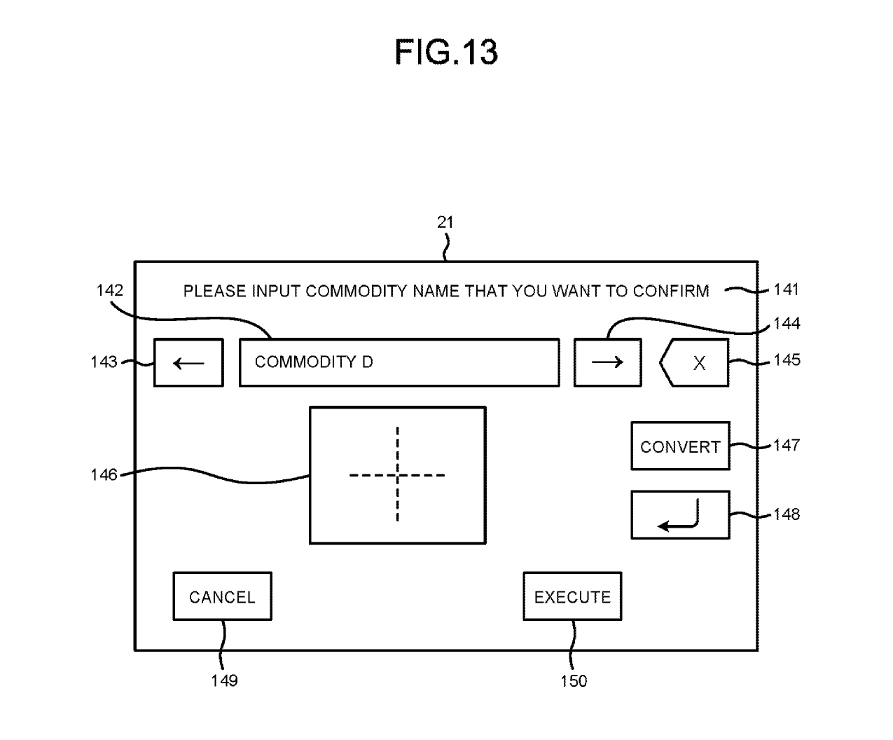

If the customer touches the stock confirmation button 105 on the registration screen (YES in ACT 7), the CPU 61 displays an input screen for stock confirmation shown in FIG. 13 on the touch panel type display section 21 (ACT 8). The input screen displays a guidance character 141 of “Please input commodity name that you want to confirm”, an input character confirmation window 142, shift keys 143 and 144, a character deleting key 145, a handwritten character input column 146, a character conversion key 147, an input confirmation key 148, a confirmation cancel key 149, a confirmation execution key 150 and the like. The character input through a touch operation or a sliding operation in the handwritten character input column 146 is displayed in the input character confirmation window 142.

If the confirmation cancel key 149 is touched (YES in ACT 9), the CPU 61 returns to ACT 4 to display the registration screen.

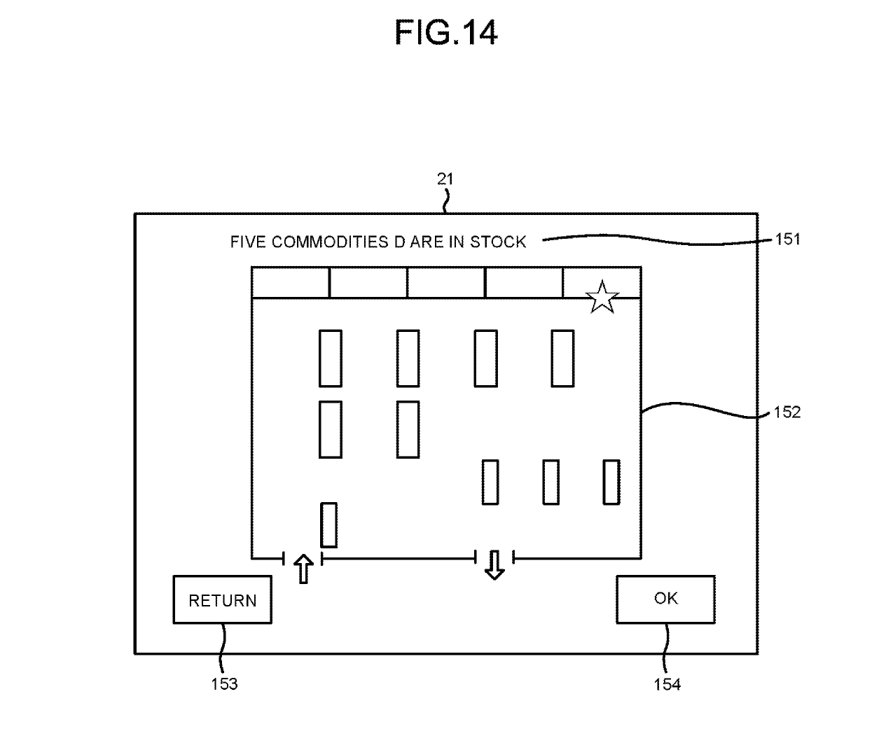

If the confirmation cancel key 149 is not touched and the confirmation execution key 150 is touched (NO in ACT 9, YES in ACT 10), the CPU 61 recognizes the commodity displayed in the input character confirmation window 142 and requests, through the wireless communication unit 66, the store server 30 to confirm how many recognized commodities are in stock in the store 1 (ACT 11). The store server 30 confirms the stock of the commodity by reference to the store information storage section 33 based on the request and sends back the confirmation result to the CPU 61. The CPU 61 displays the confirmation result display screen shown in FIG. 14 on the touch panel type display section 21 based on the reply (ACT 12)

The confirmation result display screen includes a guidance character 151 of “Five commodities D are in stock”, a plane image pattern 152, a return button 153, and an OK button 154. The “commodity D” in the guidance character 151 is an example of the commodity serving as the confirmation target. The plane image pattern 152 shows the position of the commodity serving as confirmation target with a ⋆ mark and displays the positions of the commodity display shelves 6 and 7 and the refrigerated showcase 8 as well so that the customer can easily know where the commodity serving as confirmation target is in the store 1. The customer can exactly know the stock state, the quantity and the display position of the desired commodity according to the confirmation result display screen.

If the OK button 154 of the confirmation result display screen is touched (YES in ACT 13), the CPU 61 returns to ACT 4 to display the registration screen. If the OK button 154 of the confirmation result display screen is not touched and the return button 153 is touched (NO in ACT 13, YES in ACT 14), the CPU 61 returns to ACT 8 to display the input screen.

When the customer who has put the desired commodities in the shopping cart 5 moves to the register counter 10, the shop clerk of the register counter 10 tells the customer to return the tablet terminal 20. The customer detaches the tablet terminal 20 from the base plate 5b of the shopping cart 5 and gives it to the shop clerk of the register counter 10 according to the guidance. The shop clerk receiving the tablet terminal 20 attaches the received tablet terminal 20 to the docking station 11.

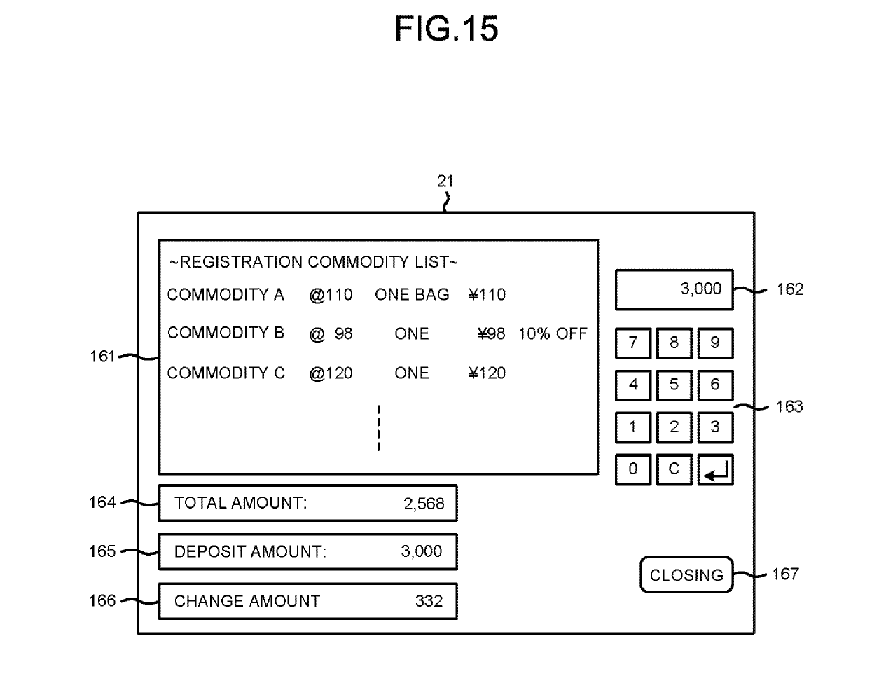

If the tablet terminal 20 is attached to the docking station 11 (NO in ACT 1, YES in ACT 2), the CPU 61 determines whether or not there is registration of commodity sales data in the RAM 63 (ACT 15). If there is registration of commodity sales data (YES in ACT 15), the CPU 61 displays a checkout screen indicating the registration content shown in FIG. 15 on the touch panel type display section 21 (ACT 16). The checkout screen displays a registration commodity list display column 161, a numeric display column 162, numeric keys 163, a total amount display column 164, a deposit amount display column 165, a change amount display column 166, a closing key 167 and the like.

The registration commodity list display column 161 displays the commodity registered by the customer, the quantity, the sub total, the related information and the like. The numeric display column 162 displays the numeral input through the touch operation on the numeric keys 163. The total amount display column 164 displays the total amount of the registration commodities in the registration commodity list display column 161. The deposit amount display column 165 displays the numeral input through the touch operation on the numeric keys 163 as the deposit amount from the customer.

The shop clerk of the register counter 10 confirms whether or not the commodities put in the shopping cart 5 is actually registered while comparing the commodities put in the shopping cart 5 with the registration commodities displayed in the registration commodity list display column 161 one by one. If all the commodities are actually registered, the shop clerk touches the closing key 167 of the checkout screen.

If the closing key 167 is touched (YES in ACT 17), the CPU 61 executes closing processing of calculating the checkout amount (total amount) based on the registration content (ACT 18). During the closing processing, the CPU 61 respectively displays the calculated checkout amount (total amount) in the total amount display column 164, displays the deposit amount in the deposit amount display column 165, displays the change amount in the change amount display column 166, and prints the commodity sales data on a receipt through a printer 45 and then discharges the receipt through the receipt issue port 13 (ACT 19).

If a commodity which is not displayed in the registration commodity list display column 161 is put in the shopping cart 5, the shop clerk of the register counter 10 holds the barcode attached to the commodity over the reading window 12 of the docking station 11. At this time, the CPU 61 reads the barcode of the commodity held over the reading window 12 through the scanner 44 and carries out a processing of adding the commodity corresponding to the read barcode to the registration content.

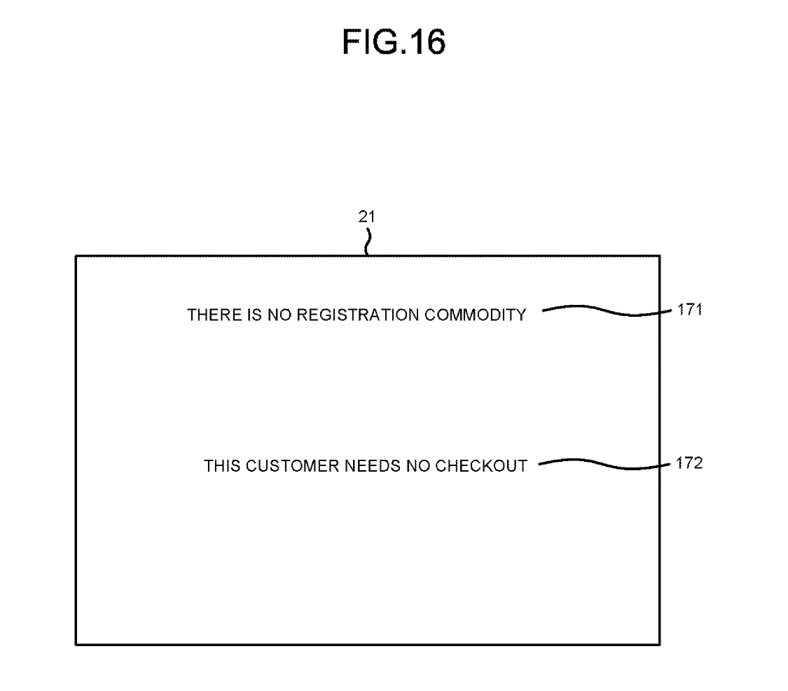

If the tablet terminal 20 is attached to the docking station 11 (YES in ACT 2), and there is no registration of commodity sales data in the RAM 63 (NO in ACT 15), the CPU 61 displays a checkout-unwanted screen shown in FIG. 16 on the touch panel type display section 21 (ACT 20). The checkout-unwanted screen displays a guidance character 171 of “There is no registration commodity”, and a guidance character 172 of “This customer needs no checkout”. The shop clerk who saw the display receives the tablet terminal 20 from the customer without carrying out checkout processing.

The shop clerk of the register counter 10 detaches the tablet terminal 20 subjected to the checkout processing or the tablet terminal 20 needing no checkout processing from the docking station 11. Then the shop clerk returns by himself/herself or requests other shop clerks to return the detached tablet terminal 20 to the terminal lending counter 9.

If the tablet terminal 20 is detached from the docking station 11 (NO in ACT 1, NO in ACT 2), the CPU 61 of the tablet terminal 20 resets the current registration content and enters into the standby mode (suspend state) (ACT 3).

As stated above, the tablet terminal 20 which can be attached to and detached from the docking station 11 is detached from the docking station 11 and lent to the customer, and the customer carries out commodity registration through the tablet terminal 20, thus, the work of scanning the commodity to read the commodity information contained in a barcode and the like in the register counter 10 is not necessary or can be reduced. For the shop clerk of the store, he/she just needs to receive the lent tablet terminal 20 from the customer and attach the tablet terminal 20 to the docking station 11 to carry out checkout processing, which reduces the workload thereof. For the store, the tablet terminal 20 of multi-function can be used in many ways, which can diversify the commodity sales forms. For the customer, the waiting time can be shortened, which can improve the customer service.

When the tablet terminal 20 is placed on the terminal lending counter 9, the tablet terminal 20 is in the suspend state for saving power, thus, the consumption of the battery 70 of the tablet terminal 20 can be restricted as much as possible, and eventually, the operation time of the tablet terminal 20 can be extended.

In the embodiment described above, the shopping cart 5 is exemplified as a commodity carrier, however, the commodity carrier is not limited to the shopping cart 5, and a hand-held shopping basket may also be used. The tablet terminal 20 may be attached to the shopping basket.

In addition, the transfer of the commodity sales data processing apparatus is generally carried out in a state in which the programs such as the control program are stored in the ROM. However, the present invention is not limited to this. The control program and the like transferred separately from a computer device may be written in a writable storage device of the computer device through an operation of a user and the like. The transfer of the control program and the, like may be carried out by recording the program in a removable recording medium, or through a communication via a network. The form of the recording medium is not limited as long as the recording medium can store programs like a CD-ROM, a memory card and the like, and is readable by an apparatus. Further, the function realized by an installed or downloaded program can also be realized through the cooperation with an OS (Operating System) installed in the apparatus.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A commodity sales data processing apparatus, comprising:
a stationary type docking station; and
a portable information terminal which can be attached to and detached from the docking station freely; wherein
the information terminal includes a reading module for reading the data attached to a commodity, a registration module for registering the data read by the reading module, a display module for displaying the registration content of the registration module, and a processing module for executing a checkout processing of calculating a checkout amount based on the registration content of the registration module if the information terminal is attached to the docking station.

2. The commodity sales data processing apparatus according to claim 1, wherein
the information terminal can be attached to and detached from a commodity carrier, and
the information terminal further includes a display module for displaying a registration screen for commodity registration when the information terminal is attached to the commodity carrier.

3. The commodity sales data processing apparatus according to claim 2, wherein
the reading module reads the data attached to the commodity in the commodity carrier in a contactless manner.

4. An information terminal which can be attached to and detached from the docking station freely and can be attached to and detached from the commodity carrier freely, comprising:
an input module configured to receive an input of data relating to the sales of a commodity;
a reading module configured to read the data attached to the commodity in the commodity carrier;
a registration module configured to register the data read by the reading module and the input data received by the input module;
a display module configured to display the registration content of the registration module; and
a processing module configured to execute a checkout processing of calculating a checkout amount based on the registration content of the registration module if the information terminal is attached to the docking station.

5. The information terminal according to claim 4, further comprising:
a display module configured to display a registration screen for commodity registration if the information terminal is attached to the commodity carrier.

6. A control method, including:
registering received input data relating to the sales of a commodity and data read from a commodity in a shopping cart or a basket;
displaying the registration content; and
executing a checkout processing of calculating a checkout amount based on the registration content.
